(19) United States
(12) Patent Application Publication
(10) Pub. No.: US 2024/0312683 A1
(43) Pub. Date: Sep. 19, 2024

(54) WOUND CORE

(71) Applicant: Alps Alpine Co., Ltd., Tokyo (JP)

(72) Inventors: Tsuyoshi SUZUKI, Niigata-ken (JP); Yuta SHIMIZU, Niigata-ken (JP)

(21) Appl. No.: 18/677,241

(22) Filed: May 29, 2024

(30) Foreign Application Priority Data
Dec. 2, 2021 (JP) 2021-196364

(51) Int. Cl. H01F 3/04; H01F 1/153

(52) U.S. Cl. CPC H01F 3/04; H01F 1/15333

(57) ABSTRACT

A wound core includes a thin strip formed of a nanocrystalline material, having an oxidized surface, and wound in multiple layers. In the wound core, the thin strip has an oxidation degree at a central portion in a width direction of the thin strip that is different from an oxidation degree at end portions located on both sides of the central portion in the width direction of the thin strip.

### CLAIM OF PRIORITY

This application is a Continuation of International Application No. PCT/JP2022/044117 filed on Nov. 30, 2022, which claims benefit of Japanese Patent Application No. 2021-196364 filed on Dec. 2, 2021. The entire contents of each application noted above are hereby incorporated by reference.

### BACKGROUND OF THE INVENTION

### 1. Field of the Invention

The present invention relates to a wound core.

### 2. Description of the Related Art

As a core of a magnetic device such as a power conversion transformer, a wound core, which is formed by winding a thin strip of a soft magnetic material (hereinafter referred to as a thin strip) into multiple layers, has been used. For example, a power conversion transformer is required to have high conversion efficiency and to have a high saturation magnetic flux density for downsizing. Thus, a soft magnetic material forming a wound core of, for example, a power conversion transformer is particularly required to have a low iron loss (core loss) and high saturation magnetic flux density.

The soft magnetic material forming the wound core is traditionally a crystalline alloy, such as a silicon steel, or an amorphous alloy, such as iron-based amorphous alloy. However, a core formed of a silicon steel has poor conversion efficiency due to its high iron loss, while having a high saturation magnetic flux density. A core formed of an iron-based amorphous alloy has a low saturation magnetic flux density, while having high conversion efficiency due to its low iron loss. In view of the above, use of a nanocrystalline material having a high saturation magnetic flux density as a soft magnetic material of the wound core has recently been considered.

A nanocrystalline material is made into a thin strip by liquid quenching or other known techniques. This thin strip of the nanocrystalline material (hereinafter referred to as a nanocrystalline thin strip) initially has an amorphous structure and can have a nanocrystalline structure when subjected to a proper heat treatment. The core formed of the nanocrystalline thin strip has a high saturation magnetic flux density of, for example, 1.7 T or higher and low iron loss. Thus, a nanocrystalline thin strip is suitably used as a soft magnetic material that forms a wound core of, for example, a power conversion transformer.

In a known technique for nanocrystallizing a nanocrystalline thin strip by heat treatment, samples taken from nanocrystallizable amorphous ribbons are subjected to heat treatment for nanocrystallization, and then a roll formed of multiple layers of the corresponding amorphous ribbons is subjected to heat treatment for nanocrystallization (see Japanese Unexamined Patent Application Publication No. 2021-9921).

In general, a nanocrystalline thin strip is a self-heating material that generates heat during nanocrystallization by heat treatment. When the nanocrystalline thin strip is nanocrystallized, it is important to properly control the temperature of the heat treatment performed on the nanocrystalline thin strip. Traditionally, the nanocrystalline thin strip is wound into a wound core having multiple layers, and then the wound core is heat treated to nanocrystallize the nanocrystalline thin strip. In this case, self-heating occurs in each of the multiple layers of the nanocrystalline thin strip that forms the wound core, and the self-heating makes it difficult to properly control the temperature of the above heat treatment. Thus, it is preferable that the above heat treatment be performed on a single (monolayer) nanocrystalline thin strip before made into a wound core.

However, during heat treatment, a single (monolayer) nanocrystalline thin strip has a larger contact area with air than a wound core, and thus the surface of the single nanocrystalline thin strip is readily oxidized, resulting in easy formation of an oxide film. If the surface of the nanocrystalline thin strip has an excessively thick oxide film, the wound core formed of the nanocrystalline thin strip will have deteriorated magnetic properties, such as saturation magnetic flux density and conversion efficiency.

### SUMMARY OF THE INVENTION

The present invention provides a wound core having excellent magnetic properties.

A wound core according to an aspect of the present invention includes a thin strip formed of a nanocrystalline material, having an oxidized surface, and wound in multiple layers. The thin strip has an oxidation degree at a central portion in a width direction of the thin strip that is different from an oxidation degree at end portions located on both sides of the central portion in the width direction of the thin strip.

In the wound core according to the aspect of the present invention, the thin strip may have a higher oxidation degree at the end portions than at the central portion.

In the wound core according to the aspect of the present invention, opposite surfaces in a thickness direction of the thin strip each may have an oxide film thickness of 5 nm or greater and 350 nm or less, and in each of the opposite surfaces in the thickness direction of the thin strip, a representative value of the oxide film thickness at the central portion may be different from a representative value of the oxide film thickness at the end portions.

In the wound core according to the aspect of the present invention, in each of opposite surfaces of the thin strip in a thickness direction, a color at the central portion may be different from a color at the end portions.

In the wound core according to the aspect of the present invention, an outermost thin strip and an innermost thin strip of the thin strip in multiple layers each may have a larger representative value of an oxide film thickness than an intermediate thin strip located between the outermost thin strip and the innermost thin strip.

The present invention has the advantage that it can provide a wound core having excellent magnetic properties.

### BRIEF DESCRIPTION OF THE DRAWINGS

FIG. 1 is a schematic view illustrating an example of a configuration of a wound core according to an embodiment of the present invention;

FIG. 2 is a schematic cross-sectional view illustrating an example of a configuration of the wound core taken along line II-II in FIG. 1;

FIG. 3 is a schematic view illustrating an example of a configuration of a nanocrystalline thin strip of the embodiment of the present invention;

FIG. 4 is a schematic cross-sectional view illustrating an example of a configuration of the nanocrystalline thin strip taken along line IV-IV in FIG. 3;

FIG. 5 is a schematic view illustrating an example of main components of a heat treatment apparatus for primary heat treatment of the nanocrystalline thin strip of the embodiment of the present invention;

FIG. 6 is a top view of the heat treatment apparatus illustrated in FIG. 5;

FIG. 7 is a schematic cross-sectional view illustrating an example of a configuration of the heat treatment apparatus taken along line VII-VII in FIG. 6;

FIG. 8 is a flowchart indicating an example of a method of producing the wound core according to the embodiment of the present invention; and

FIG. 9 is a schematic view illustrating areas for measurement of an oxide film thickness of a thin strip sample in Example.

### DESCRIPTION OF THE PREFERRED EMBODIMENTS

Hereinafter, a preferable embodiment of a wound core according to the present invention will be described in detail with reference to the accompanying drawings. The present invention should not be limited by this embodiment. It should be noted that the drawings are schematic, and dimensional relations between components and scales of components, for example, may differ from actual relations and actual scales in some cases. Dimensional relations or scales may vary between the figures in some cases. In the drawings, the same components are denoted by the same reference numerals.

### Wound Core

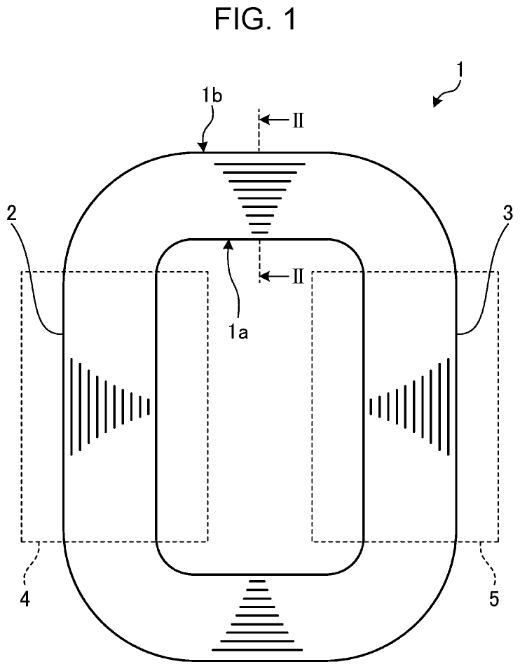

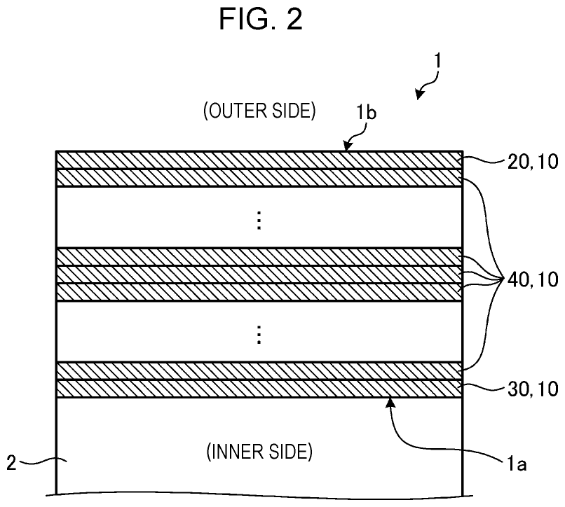

Hereinafter, a wound core according to an embodiment of the present invention will be described in detail. FIG. 1 is a schematic view illustrating an example of a configuration of a wound core according to an embodiment of the present invention. FIG. 2 is a schematic cross-sectional view illustrating an example of a cross-sectional configuration of the wound core taken along line II-II in FIG. 1. The wound core 1 according to the embodiment of the present invention is, for example, a wound core for a power conversion transformer and has two legs 2 and 3 facing each other, as illustrated in FIG. 1.

More specifically, as illustrated in FIGS. 1 and 2, the wound core 1 is formed of a wound multi-layer nanocrystalline thin strip 10 and is an annular structure having a stacked structure including the multi-layer nanocrystalline thin strip 10. For example, in plan view in FIG. 1, the wound core 1 has a rounded rectangular annular shape having an inner surface 1a and an outer surface 1b. The thickness of the wound core 1 corresponds to the distance between the inner surface 1a and the outer surface 1b in FIG. 1, i.e., the thickness of the stacked structure composed of the multi-layer nanocrystalline thin strip 10 illustrated in FIG. 2. The width of the wound core 1 corresponds to the width of the nanocrystalline thin strip 10.

As illustrated in FIG. 1, the legs 2 and 3 of the wound core 1 face each other in the thickness direction. Of the legs 2 and 3, the leg 2 has an input side coiled wire 4 and the leg 3 has an output side coiled wire 5. The wound core 1 generates an alternating magnetic field (fluctuating magnetic field) when an alternating current flows through the input side coiled wire 4. This alternating magnetic field is again converted into a current by the output side coiled wire 5, and the current is output through the coiled wire 5.

Furthermore, as illustrated in FIG. 2, the nanocrystalline thin strip 10 forming the wound core 1 includes an outermost thin strip 20, an innermost thin strip 30, and an intermediate thin strip 40. The outermost thin strip 20 is the nanocrystalline thin strip 10 that is located at the outermost side of the wound core 1. In other words, of the opposite surfaces of the outermost thin strip 20 in the thickness direction, the outer surface is exposed to the outside of the wound core 1 and is the outer surface 1b (see FIGS. 1 and 2) of the wound core 1. The innermost thin strip 30 is the nanocrystalline thin strip 10 that is located at the innermost side of the wound core 1. In other words, of the opposite surfaces in the thickness direction of the innermost thin strip 30, the inner surface is exposed to the inside of the wound core 1 and is the inner surface 1a (see FIGS. 1 and 2) of the wound core 1. The intermediate thin strip 40 is the nanocrystalline thin strip 10 that is located between the outermost thin strip 20 and the innermost thin strip 30. For example, as illustrated in FIG. 2, the intermediate thin strip 40 located between the outermost thin strip 20 and the innermost thin strip 30 has multiple layers. In this specification, in view of the above, the outermost thin strip 20, the innermost thin strip 30, and the multi-layer intermediate thin strip 40 may be collectively referred to as the nanocrystalline thin strip 10 when they are not described without being distinguished from each other.

Although not illustrated, the stacked structure of the above multi-layer nanocrystalline thin strip 10 may have an overlap configuration in which the end portions of the nanocrystalline thin strip 10 in the lengthwise direction overlap each other in the stacking direction (thickness direction), or a step-lap configuration in which the end portions face each other with a predetermined distance between them. Alternatively, the stacked structure of the multi-layer nanocrystalline thin strip 10 may have the overlap configuration and the step-lap configuration in combination.

### Nanocrystalline Thin Strip

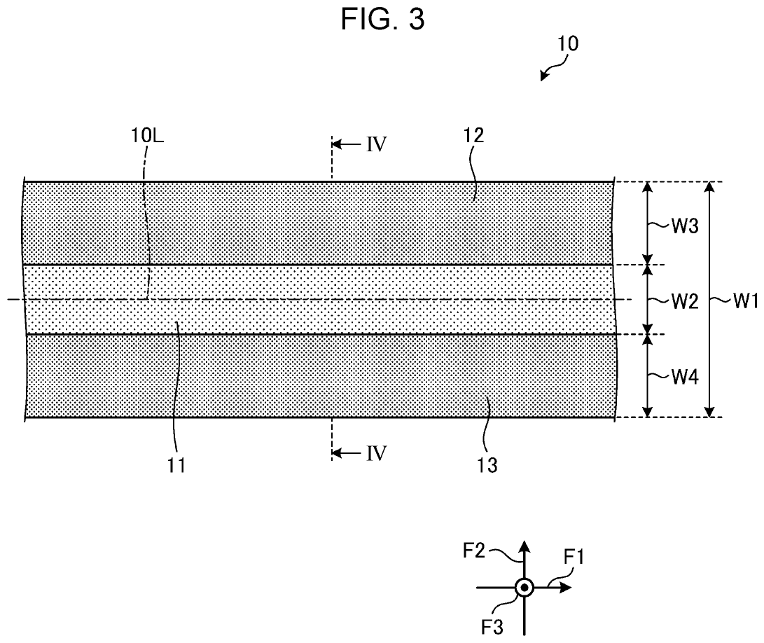

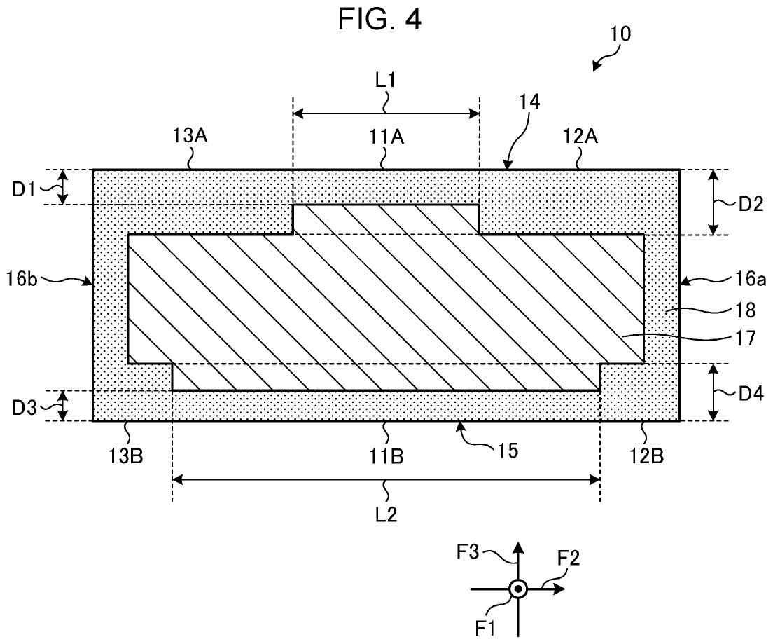

Next, the nanocrystalline thin strip 10 forming the wound core 1 according to the embodiment of the present invention will be described in detail. FIG. 3 is a schematic view illustrating an example of a configuration of the nanocrystalline thin strip of the embodiment of the present invention. FIG. 3 schematically illustrates a plan view of a main surface of the nanocrystalline thin strip 10. FIG. 4 is a schematic cross-sectional view illustrating an example of a configuration of the nanocrystalline thin strip taken along line IV-IV in FIG. 3.

In FIGS. 3 and 4, for convenience of explanation of the nanocrystalline thin strip 10, a lengthwise direction F1, a width direction F2, and a thickness direction F3 are indicated. The lengthwise direction F1 is the lengthwise direction of the nanocrystalline thin strip 10, the width direction F2 is the width direction (widthwise direction) of the nanocrystalline thin strip 10, and the thickness direction F3 is the thickness direction of the nanocrystalline thin strip 10. These three directions are orthogonal to each other. These three directions should not be construed as limiting the present invention, and the same also applies to thin strips other than the nanocrystalline thin strip 10.

The nanocrystalline thin strip 10 of the embodiment of the present invention is a thin strip that is formed of a nanocrystalline material and has an oxidized surface. The nanocrystalline material is a soft magnetic material that can be made into thin strips by known techniques, such as liquid quenching, and has an amorphous structure that can be nanocrystallized by heat treatment. In other words, the nanocrystalline thin strip 10 has an amorphous structure in its initial state before heat treatment for nanocrystallization and has an amorphous structure and a nanocrystalline structure after the heat treatment.

Specifically, as illustrated in FIGS. 3 and 4, after heat treatment for nanocrystallization, the nanocrystalline thin strip 10 has an internal structure 17 having an amorphous structure and a nanocrystalline structure in a mixed manner and has an oxidized surface. The nanocrystalline structure in the internal structure 17 is obtained by nanocrystallizing an amorphous structure by heat treatment. In this nanocrystalline thin strip 10, the oxidation degree at a central portion 11 in the width direction F2 is different from that at end portions 12 and 13 in the width direction F2. In this specification, the oxidation degree refers to the level of oxidation on the surface of the nanocrystalline thin strip. An indicator of the oxidation degree may be, for example, the thickness of the oxide film on the surface of the nanocrystalline thin strip (oxide film thickness) or color.

As illustrated in FIG. 3, the central portion 11 in the width direction F2 of the nanocrystalline thin strip 10 is an area having a width W2 centered on a central axis 10L extending in the lengthwise direction F1 of the nanocrystalline thin strip 10. The ratio of the width W2 to the width W1 of the nanocrystalline thin strip 10 is less than 1. As illustrated in FIG. 4, the nanocrystalline thin strip 10 has a first strip surface 14 and a second strip surface 15 as main surfaces on opposite sides in the thickness direction F3. As illustrated in FIG. 4, in this nanocrystalline thin strip 10, the above-described central portion 11 includes a central portion 11A in the width direction F2 of the first strip surface 14 and a central portion 11B in the width direction F2 of the second strip surface 15. For example, the width W2 of the central portion 11 is different between the central portion 11A of the first strip surface 14, which is one of the opposite surfaces of the nanocrystalline thin strip 10 in the thickness direction F3, and the central portion 11B of the second strip surface 15, which is the other of the opposite surfaces.

Furthermore, as illustrated in FIG. 3, the opposite end portions 12 and 13 in the width direction F2 of the nanocrystalline thin strip 10 are areas on both sides of the central portion 11 in the width direction F2 of the nanocrystalline thin strip 10. The end portions 12 and 13 each have an edge in the width direction F2 of the nanocrystalline thin strip 10. Of the two end portions 12 and 13, one end portion 12 has a width W3, and the other end portion 13 has a width W4. The width W3 of the one end portion 12 is substantially the same as the width W4 of the other end portion 13. For example, as illustrated in FIG. 3, the width W2 of the central portion 11 plus the widths W3 and W4 of the end portions 12 and 13 equal to the width W1 of the nanocrystalline thin strip 10. As illustrated in FIG. 4, in the nanocrystalline thin strip 10, the above-described end portions 12 and 13 include opposite end portions 12A and 13A in the width direction F2 of the first strip surface 14 and opposite end portions 12B and 13B in the width direction F2 of the second strip surface 15.

As illustrated in FIG. 4, in addition to the above-described first and second strip surfaces 14 and 15, the nanocrystalline thin strip 10 has side surfaces 16a and 16b as opposite end surfaces in the width direction F2. In this nanocrystalline thin strip 10, for example, the first strip surface 14 is a free surface of the nanocrystalline thin strip 10, and the second strip surface 15 is a roll surface of the nanocrystalline thin strip 10.

In the production of thin strips by liquid quenching or other techniques, thin strips are sequentially produced by ejection of molten metal onto a rotating casting roll (cooling roll). The roll surface is one of the surfaces in the thickness direction of the thin strip that is in contact with the casting roll. The free surface is the surface opposite to the roll surface, i.e., the surface that is not in contact with the casting roll. When the thin strip is produced by liquid quenching or other techniques in air (in an air atmosphere), the free surface of the produced thin strip is in contact with air. Thus, at the completion of production, the nanocrystalline thin strip 10 produced by liquid quenching tends to have a higher oxidation degree at the free surface than at the roll surface. The distribution of the oxidation degree of the nanocrystalline thin strip 10 is not determined by the roll surface and the free surface. Depending on the heat treatment technique for nanocrystallization, the relation in oxidation degree between the roll surface and the free surface may be reversed.

The nanocrystalline thin strip 10 having the roll surface and the free surface is oxidized at surfaces such as the first strip surface 14, the second strip surface 15, and the side surfaces 16a and 16b, for example, during the process of producing the thin strip by liquid quenching or heat treatment for nanocrystallization. Thus, as illustrated in FIG. 4, an oxide film 18 is formed on the nanocrystalline thin strip 10 over the entire area of the first strip surface 14, the second strip surface 15, and the side surfaces 16a and 16b. The oxide film 18 grows inwardly from the surface of the nanocrystalline thin strip 10. Thus, as the oxide film 18 grows, the volume of at least one of the amorphous structure and the nanocrystalline structure decreases in the internal structure 17 of the nanocrystalline thin strip 10. The thickness of the oxide film 18 (hereinafter referred to as an oxide film thickness) corresponds to the dimension (depth) in the direction from the surface of the nanocrystalline thin strip 10 to the interior and tends to be larger in the highly oxidized areas of the nanocrystalline thin strip 10 and smaller in the less oxidized areas.

In the embodiment of the present invention, the nanocrystalline thin strip 10 differs in oxidation degree between the central portion 11 in the width direction F2 and the end portions 12 and 13. Thus, the nanocrystalline thin strip 10 differs in representative value of the oxide film thickness between the central portion 11 and the end portions 12 and 13. For example, the nanocrystalline thin strip 10 has a higher oxidation degree at the opposite end portions 12 and 13 in the width direction F2 than at the central portion 11. In this nanocrystalline thin strip 10, the representative value of the oxide film thickness at the end portions 12 and 13 is higher than that at the central portion 11. The representative values of the oxide film thickness are oxide film thicknesses at representative sites of the central portion 11 and the end portions 12 and 13 in the width direction F2 of the nanocrystalline thin strip 10. For example, the representative sites are aligned in the stacking direction (thickness direction F3) in the multi-layer nanocrystalline thin strip 10 (see FIG. 2).

Specifically, as illustrated in FIG. 4, the oxide film 18 on the first strip surface 14 of the nanocrystalline thin strip 10 has an oxide film thickness D1 at the central portion 11A in the width direction F2 and an oxide film thickness D2 at the opposite end portions 12A and 13A in the width direction F2. The oxide film 18 on the second strip surface 15 of the nanocrystalline thin strip 10 has an oxide film thickness D3 at the central portion 11B in the width direction F2 and has an oxide film thickness D4 at the opposite end portions 12B and 13B in the width direction F2. The oxide film thickness D1 is a representative value of the oxide film thickness at the central portion 11A in the width direction F2, and the oxide film thickness D2 is a representative value of the oxide film thickness at the opposite end portions 12A and 13A in the width direction F2. The oxide film thickness D3 is a representative value of the oxide film thickness at the central portion 11B in the width direction F2, and the oxide film thickness D4 is a representative value of the oxide film thickness at the opposite end portions 12B and 13B in the width direction F2.

The oxide film thicknesses D1 to D4 at the respective portions of the oxide film 18 in FIG. 4 are schematically illustrated as having constant representative values. However, in practice, the thickness of the oxide film 18 is not necessarily uniform at each of the central portions 11A and 11B and the end portions 12A, 12B, 13A, and 13B in the width direction F2 of the nanocrystalline thin strip 10.

As illustrated in FIG. 4, in the first strip surface 14 of the nanocrystalline thin strip 10, the oxide film thickness DI at the central portion 11A in the width direction F2 is different from the oxide film thickness D2 at the opposite end portions 12A and 13A in the width direction F2. In the second strip surface 15 of the nanocrystalline thin strip 10, the oxide film thickness D3 at the central portion 11B in the width direction F2 is different from the oxide film thickness D4 at the end portions 12B and 13B in the width direction F2. For example, in the first strip surface 14 of the nanocrystalline thin strip 10, the oxide film thickness D2 at the end portions 12A and 13A is larger than the oxide film thickness D1 at the central portion 11A. In the second strip surface 15 of the nanocrystalline thin strip 10, the oxide film thickness D4 at the end portions 12B and 13B is larger than the oxide film thickness D3 at the central portion 11B.

As illustrated in FIG. 4, when the first strip surface 14 of the nanocrystalline thin strip 10 has a higher oxidation degree than the second strip surface 15, the oxide film thickness D1 at the central portion 11A of the first strip surface 14 is larger than the oxide film thickness D3 at the central portion 11B of the second strip surface 15. In addition, the oxide film thickness D2 at the end portions 12A and 13A of the first strip surface 14 is larger than the oxide film thickness D4 at the end portions 12B and 13B of the second strip surface 15. As illustrated in FIG. 4, the distance L1 between the oxide film 18 at one end portion 12A and the oxide film 18 at the other end portion 13A of the first strip surface 14 is smaller than the distance L2 between the oxide film 18 at one end portion 12B and the oxide film 18 at the other end portion 13B of the second strip surface 15.

The oxide film 18 preferably has a thickness within a predetermined range defined by highest and lowest values. For example, the opposite surfaces of the nanocrystalline thin strip 10 in the thickness direction F3 (first and second strip surfaces 14 and 15) each preferably have an oxide film thickness of 5 nm or larger and 350 nm or less, and more preferably 65 nm or larger and 315 nm or less. This can reduce the possibility that the core loss, saturation magnetic flux density, and other magnetic properties of the wound core 1 formed of the nanocrystalline thin strip 10 will be deteriorated by an excessive increase in the thickness of the oxide film 18 of the nanocrystalline thin strip 10. When the oxide film thickness is within the range of 5 nm or larger and 350 nm or less, the wound core 1 can have a high saturation magnetic flux density of, for example, 1.7 T or more.

In the wound core 1 according to the embodiment of the present invention (see FIG. 1), the representative value of the oxide film thickness in each of the outermost thin strip 20 and innermost thin strip 30 (see FIG. 2) of the multi-layer nanocrystalline thin strip 10 is larger than the representative value of the oxide film thickness in the intermediate thin strip 40. In particular, the outer strip surface (e.g., the first strip surface 14) of the outermost thin strip 20 corresponds to the outer surface 1b of the wound core 1, and the inner strip surface (e.g., the second strip surface 15) of the innermost thin stripe 30 corresponds to the inner surface 1a of the wound core 1. The outer strip surface of the outermost thin strip 20 and the inner strip surface of the innermost thin strip 30 each have a larger representative value of the oxide film thickness than the opposite surfaces of the intermediate thin strip 40 in the thickness direction F3. The difference in the representative values of the oxide film thicknesses is preferably within a range that allows the wound core 1 to have improved weather resistance while allowing the wound core 1 to keep its excellent magnetic properties.

The multiple layers of the intermediate thin strip 40 each preferably have a smaller representative value of the oxide film thickness at, of the opposite surfaces in the thickness direction F3, the inner strip surface (e.g., the second strip surface 15) than at the outer strip surface (e.g., the first strip surface 14).

The wound core 1 having the above-described configuration can keep the core loss less than or equal to the target value. This target core loss is, for example, a core loss per unit mass at a time when a maximum magnetic flux density of 1.6 T is generated at a frequency of 50 Hz, specifically 1.0 W/kg or less. More preferably, the core loss is less than 0.5 W/kg. In addition, the oxide films on the outer strip surface of the outermost thin strip 20 and the inner strip surface of the innermost thin strip 30 described above can protect the outer surface 1b and the inner surface 1a of the wound core 1, improving the weather resistance of the wound core 1 while allowing the wound core 1 to keep its excellent magnetic properties.

Attention may be paid to the color as an indicator of the oxidation degree of the nanocrystalline thin strip 10. Specifically, in each of the opposite surfaces of the nanocrystalline thin strip 10 in the thickness direction F3, a color at the central portion 11 in the width direction F2 is different from a color at the end portions 12 and 13.

Specifically, in the first strip surface 14 located at the end in the thickness direction F3 of the nanocrystalline thin strip 10 illustrated in FIG. 4, the color at the central portion 11A in the width direction F2 is different from that at the end portions 12A and 13A. More specifically, the oxidation degree at the central portion 11A is lower than that at the end portions 12A and 13A, and thus the color at the central portion 11A is closer to a color of the metallic luster of the nanocrystalline thin strip 10 before oxidation than that at the end portions 12A and 13A. In contrast, the color at the end portions 12A and 13A is farther from that of the metallic luster of the nanocrystalline thin strip 10 before oxidation, for example, closer to purple or blue, than the color at the central portion 11A is. In the first strip surface 14, a stripe pattern formed by the above-described difference in color extends in the lengthwise direction F1 of the nanocrystalline thin strip 10 (see FIG. 3).

In the second strip surface 15 located at the end in the thickness direction F3 of the nanocrystalline thin strip 10 illustrated in FIG. 4, the color at the central portion 11B in the width direction F2 is different from that at the end portions 12B and 13B. The difference in color between the central portion 11B and the two end portions 12B and 13B is the same as that in the above-described first strip surface 14, except that the color range is different. Although not illustrated in the drawings, also in the second strip surface 15, a stripe pattern formed by the above-described difference in color extends in the lengthwise direction F1 of the nanocrystalline thin strip 10.

In the wound core 1 according to the embodiment of the invention, the color as an indicator of the oxidation degree of the nanocrystalline thin strip 10 differs between the strip surfaces of the outermost thin strip 20 and the innermost thin strip 30 and the strip surfaces of the intermediate thin strip 40.

Examples of the soft magnetic material forming the above-described nanocrystalline thin strip 10 include an iron-based nanocrystalline material that contains iron (Fe) as a main component. The iron-based nanocrystalline material may contain an α-Fe crystal structure having a bcc structure to improve magnetic properties, for example, to achieve a higher saturation magnetic flux density. The thickness of the nanocrystalline thin strip 10 is typically, for example, 25 μm.

### Heat Treatment

Next, the heat treatment for nanocrystallization of the nanocrystalline thin strip 10 according to the embodiment of the present invention will be described in detail. Primary heat treatment is performed on a monolayer nanocrystalline thin strip 10 before wounding in multiple layers into the wound core 1, and secondary heat treatment is performed on the multi-layer nanocrystalline thin strip 10 in the form of the wound core 1. The primary heat treatment is performed to nanocrystallize the nanocrystalline thin strip 10. The internal structure 17 (see FIG. 4) of the nanocrystalline thin strip 10 after nanocrystallization has a nanocrystalline structure and an amorphous structure in a mixed manner. In the nanocrystalline thin strip 10 after the primary heat treatment, the nanocrystallization is mostly completed. The secondary heat treatment allows the rest of the nanocrystalline thin strip 10 to be nanocrystallized and reduces the stress in the multi-layer nanocrystalline thin strip 10 in the form of the wound core 1. The primary heat treatment of the nanocrystalline thin strip 10 will be described in detail below.

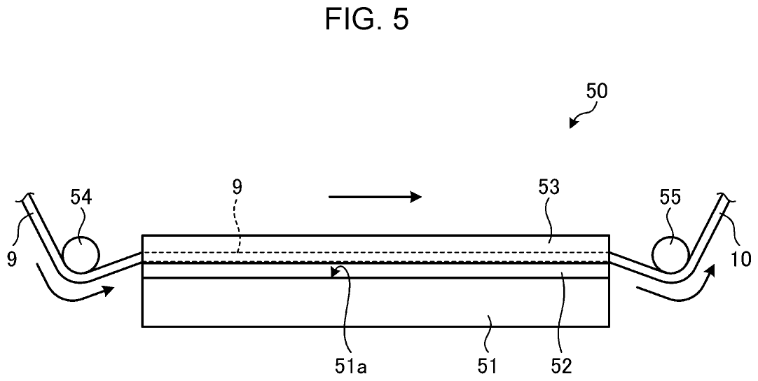

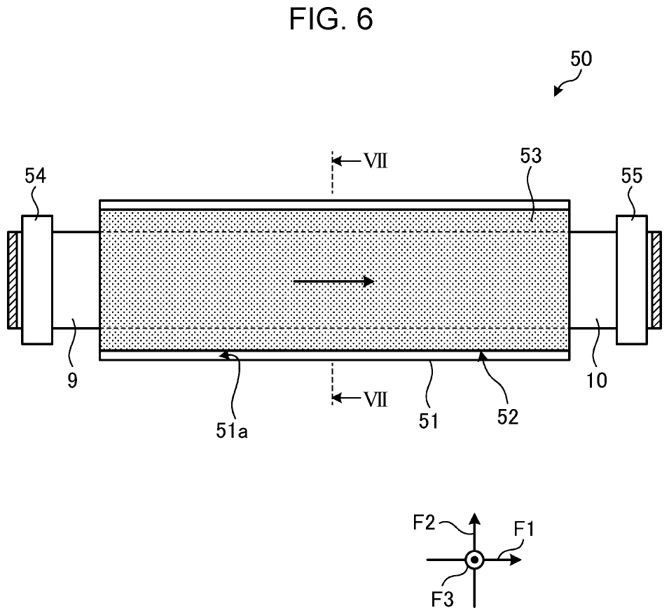

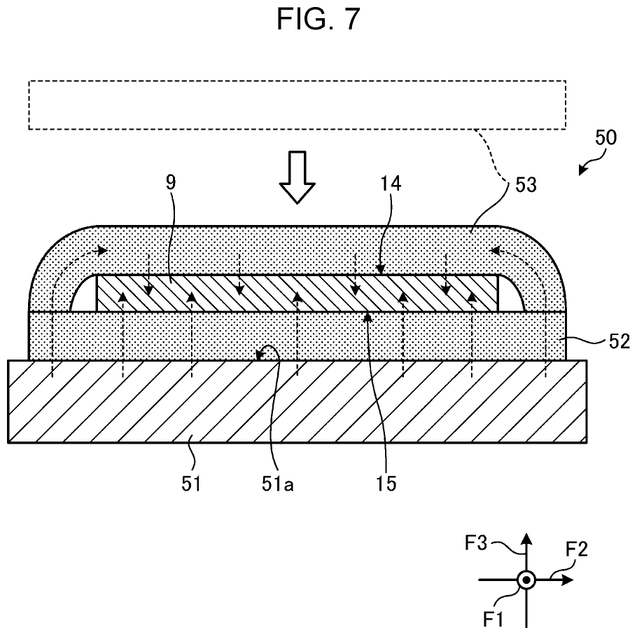

FIG. 5 is a schematic view illustrating an example of main components of a heat treatment apparatus for primary heat treatment of the nanocrystalline thin strip according to the embodiment of the present invention. In FIG. 5, the main components of the heat treatment apparatus 50 are schematically illustrated in a side view. FIG. 6 is a top view of the heat treatment apparatus illustrated in FIG. 5. FIG. 7 is a schematic cross-sectional view illustrating an example of a configuration of the heat treatment apparatus taken along line VII-VII in FIG. 6. In FIGS. 6 and 7, the lengthwise direction F1, the width direction F2, and the thickness direction F3 indicate the lengthwise direction, the width direction, and the thickness direction, respectively, of the nanocrystalline thin strip 9 on the heating surface 51a of the heater 51 of the heat treatment apparatus 50.

The heat treatment apparatus 50 of the embodiment of the present invention is an apparatus that performs primary heat treatment on the nanocrystalline thin strip 9 to be subjected to the primary heat treatment while transporting the thin strip 9 using a roll-to-roll process. The nanocrystalline thin strip 9 is a thin strip of a soft magnetic material produced by a known technique such as liquid quenching and becomes a nanocrystalline thin strip 10 in a nanocrystallized state when subjected to the primary heat treatment. In other words, the nanocrystalline thin strip 9 is the nanocrystalline thin strip 10 before the primary heat treatment (initial state) whose internal structure is mainly amorphous and is the same as the nanocrystalline thin strip 10 except for the proportion of the nanocrystalline structure in the internal structure and the oxidation degree of the surface.

As illustrated in FIGS. 5 and 6, the heat treatment apparatus 50 includes a heater 51, a fixed sheet 52, and a movable sheet 53. The heat treatment apparatus 50 further includes a guide roll 54 on the entry side and a guide roll 55 on the exit side of the heater 51. Although not illustrated in the drawings, upstream of the guide roll 54 on the entry side of the heater 51, the heat treatment apparatus 50 includes, for example, an unwinding roll that unwinds the nanocrystalline thin strip 9, multiple guide rolls that guide the unwound nanocrystalline thin strip 9 toward the heater 51 while flattening the curve, a tensioning device that applies tensile force to the nanocrystalline thin strip 9. Furthermore, downstream of the guide roll 55 on the exit side of the heater 51, the heat treatment apparatus 50 includes, for example, a take-up roll that winds up the nanocrystalline thin strip 10 after the primary heat treatment, and multiple guide rolls that guide the nanocrystalline thin strip 10 from the heater 51 toward the take-up roller.

As illustrated in FIGS. 5 and 6, the heater 51 has a heating surface 51a on a predetermined surface (e.g., an upper surface) facing the transportation route of the nanocrystalline thin strip 9 and emits heat required for the primary heat treatment from the heating surface 51a. The fixed sheet 52 is placed on the heating surface 51a of the heater 51, as illustrated in FIGS. 5 to 7. The fixed sheet 52 has a surface in close contact with the heating surface 51a of the heater 51. In this state, the second strip surface 15 of the nanocrystalline thin strip 9 that is sequentially transported slides on the fixed sheet 52.

The movable sheet 53 is a movable sheet having, for example, a drive unit (not illustrated) and faces the fixed sheet 52 on the heating surface 51a with the transport route of the nanocrystalline thin strip 9 therebetween, as illustrated in FIGS. 5 to 7. As illustrated in FIG. 7, the movable sheet 53 can move toward the fixed sheet 52. This allows the movable sheet 53 to press the fixed sheet 52 and the nanocrystalline thin strip 9 against the heating surface 51a of the heater 51 and sandwich the nanocrystalline thin strip 9 between the movable sheet 53 and the fixed sheet 52. Furthermore, the movable sheet 53 is in close contact with the fixed sheet 52 at end portions in the width direction and thus covers the nanocrystalline thin strip 9 on the fixed sheet 52. The width direction of the fixed sheet 52 and the movable sheet 53 is the same as the width direction F2 of the nanocrystalline thin strip 9 located on the heating surface 51a of the heater 51. In the above state, the first strip surface 14 of the nanocrystalline thin strip 9 that is sequentially transported slides on the movable sheet 53. As illustrated in FIGS. 5 to 7, it is preferable that the movable sheet 53 sandwich the nanocrystalline thin strip 9 between the movable sheet 53 and the fixed sheet 52 over the entire area in the lengthwise direction F1 of the nanocrystalline thin strip 9 on the heating surface 51a of the heater 51. The movable sheet 53 can also move in a direction away from the fixed sheet 52. This terminates sandwiching of the nanocrystalline thin strip 9 between the movable sheet 53 and the fixed sheet 52.

The fixed sheet 52 and the movable sheet 53 described above are each formed of a material having a higher thermal conductivity and reducing ability than the nanocrystalline thin strip 9. Examples of the material include titanium-based materials containing titanium, aluminum-based materials containing aluminum, and carbon-based materials containing carbon.

As illustrated in FIGS. 5 and 6, the guide rolls 54 and 55 are positioned on the entry and exit sides of the heater 51, respectively, to guide the nanocrystalline thin strip 9 or 10 at an angle to the heating surface 51a of the heater 51. For example, the guide roll 54 on the entry side guides the nanocrystalline thin strip 9 obliquely upward from the heater 51 side to a surface where the nanocrystalline thin strip 9 slides on the fixed sheet 52. The guide roll 55 on the exit side guides the nanocrystalline thin strip 10 after the primary heat treatment obliquely downward from the surface where the nanocrystalline thin strip 10 slides on the fixed sheet 52.

In the heat treatment apparatus 50 having the above-described configuration, the nanocrystalline thin strip 9 to be treated is unwound from the unwinding roll (not illustrated) and then sequentially transported between the fixed sheet 52 and the movable sheet 53 on the heater 51, for example, via the guide roll 54 on the entry side. The nanocrystalline thin strip 9 is transported along the heating surface 51a of the heater 51 while being sandwiched between and covered by the fixed sheet 52 and the movable sheet 53 in the thickness direction F3. At this time, the nanocrystalline thin strip 9 receives tensile force in the lengthwise direction F1 during transport and also pressing force from the movable sheet 53. These tensile and pressing forces allow the nanocrystalline thin strip 9 to be transported on the heater 51 with the second strip surface 15 of the nanocrystalline thin strip 9 being pressed against the fixed sheet 52, which is in close contact with the heating surface 51a of the heater 51.

The nanocrystalline thin strip 9 being transported on the heating surface 51a while being sandwiched between and covered by the fixed sheet 52 and the movable sheet 53 is subjected to the primary heat treatment at the desired temperature by heating from the heater 51 through the fixed sheet 52.

More specifically, as illustrated by the dashed arrows in FIG. 7, heat from the heater 51 is sequentially transferred through the fixed sheet 52, which has a higher thermal conductivity than the nanocrystalline thin strip 9, to the nanocrystalline thin strip 9 being transported. Additionally, the heat from the heater 51 is transferred through the fixed sheet 52 to the movable sheet 53, which has a higher thermal conductivity than the nanocrystalline thin strip 9, and then is sequentially transferred through the movable sheet 53 to the nanocrystalline thin strip 9 being transported. Thus, the nanocrystalline thin strip 9 can be heated from opposite surfaces (the first and second strip surfaces 14 and 15) in the thickness direction F3.

In addition to the above, the heat treatment apparatus 50 sandwiches the nanocrystalline thin strip 9 on the heating surface 51a of the heater 51 between the fixed sheet 52 and the movable sheet 53 from opposite sides in the thickness direction F3. This can reduce the contact area of the nanocrystalline thin strip 9 with air, reducing direct heat dissipation from the nanocrystalline thin strip 9 to air.

The above-described heating action on the nanocrystal thin strip 9 from both the first and second strip surfaces 14 and 15 and the reduction in the direct heat dissipation to air make the temperature distribution inside the nanocrystalline thin strip 9 smaller. This can increase the temperature increase rate of the nanocrystalline thin strip 9 by the primary heat treatment to as high as 300° C./min or higher. This enables the crystal grain size of the nanocrystalline thin strip 10 after the primary heat treatment to be the target nanocrystalline structure crystal grain size (e.g., the crystal grain size of 30 nm or less, preferably 20 nm or less), allowing the wound core 1 formed of the nanocrystalline thin strip 10 to have good magnetic properties.

Furthermore, as described above, the fixed sheet 52 and the movable sheet 53 that sandwich the nanocrystalline thin strip 9 have a reducing ability, and thus oxidation of the nanocrystalline thin strip 9 during the primary heat treatment can be inhibited. This prevents the nanocrystalline thin strip 10 after the primary heat treatment from having an excessively thick oxide film. Furthermore, the fixed sheet 52 and the movable sheet 53 sandwich the nanocrystalline thin strip 9 from opposite sides in the thickness direction F3, reducing the amount of air entering to the second strip surface 15, which faces the heating surface 51a of the heater 51 (heater side surface), and the first strip surface 14 (air side surface), in the width direction F2. This can reduce the area having a thick oxide film in each of the first strip surface 14 and the second strip surface 15 of the nanocrystalline thin strip 10 after the primary heat treatment. As described above, the thickness and width of the oxide film of the nanocrystalline thin strip 10 can be reduced, and thus the magnetic properties of the wound core 1 formed of the nanocrystalline thin strip 10 are less likely to be deteriorated.

After the primary heat treatment is performed on the above-described nanocrystalline thin strip 9, in the heat treatment apparatus 50, the nanocrystalline thin strip 10 after the primary heat treatment is taken out of the heater 51. The nanocrystalline thin strip 10 is transported via the guide roll 55 on the exit side, cooled to room temperature by, for example, air cooling, and then sequentially wound into a roll by a take-up roll (not illustrated).

### Method of Producing Wound Core

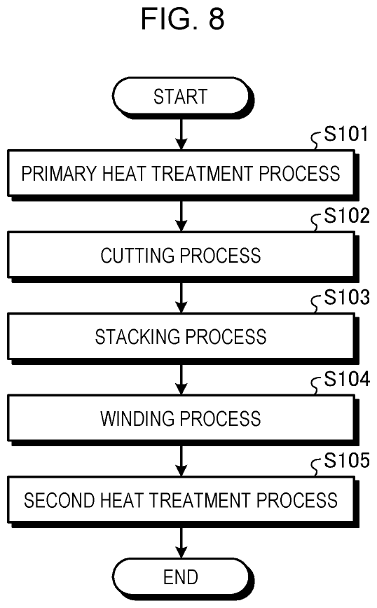

Next, a method of producing the wound core 1 according to the embodiment of the present invention will be described in detail. FIG. 8 is a flowchart indicating an example of a method of producing the wound core according to the embodiment of the present invention. The wound core 1 (see FIGS. 1 and 2) is produced by sequentially performing processes indicated in FIG. 8.

Specifically, as indicated in FIG. 8, the method of producing the wound core 1 first includes a primary heat treatment process for nanocrystallizing the nanocrystalline thin strip 9, which is the material for the wound core 1 (step S101).

In the primary heat treatment process at step S101, the nanocrystalline thin strip 9 (the nanocrystalline thin strip 10 in the initial state), which has been prepared in advance by a known technique, such as liquid quenching, is prepared in the form of a roll, and the roll is set in the heat treatment apparatus 50 for primary heat treatment (see FIGS. 5 to 7). The heat treatment apparatus 50 then performs the primary heat treatment as described above while transporting the nanocrystalline thin strip 9 using a roll-to-roll process. This produces a nanocrystalline thin strip 10 in which nanocrystallization of the nanocrystalline thin strip 9 has progressed to the target value (e.g., to a nanocrystallization progress degree of 95%). The produced nanocrystalline thin strip 10 is sequentially taken out of the heater 51, cooled to room temperature by, for example, air cooling, and then wound into a roll.

The temperature of the heater 51 during the primary heat treatment of the nanocrystalline thin strip 9 is adjusted, for example, by taking into account the heat treatment temperature of the nanocrystalline thin strip 9 and the transport rate. For example, the first crystallization temperature at which a-Fe crystals precipitate inside the nanocrystalline thin strip 9 is used as a reference temperature, and the heat treatment temperature of the nanocrystalline thin strip 9 is set within a range of −50° C. from the reference temperature to +150° C. from the reference temperature. The temperature of the heater 51 is adjusted so that the nanocrystalline thin strip 9 being transported can be heated to the above-described heat treatment temperature.

After the primary heat treatment process at step S101, a cutting process is performed to cut the nanocrystalline thin strip 10 (step S102). In the cutting process at step S102, the roll of the nanocrystalline thin strip 10 is set in a cutting apparatus, and the nanocrystalline thin strip 10 is sequentially unrolled from the roll. The unrolled nanocrystalline thin strip 10 is then cut sequentially into a length required to form the desired wound core 1 (hereinafter referred to as a “target length”). Thus, multiple layers of the nanocrystalline thin strip 10 having the target length are produced. Examples of the method of cutting the nanocrystalline thin strip 10 include laser cutting.

After the cutting process at step S102, a stacking process is performed to stack the layers of the nanocrystalline thin strip 10 (step S103). In the stacking process at step S103, the cut pieces of the nanocrystalline thin strip 10 having the target length are stacked in multiple layers in the thickness direction F3. For example, the layers of the nanocrystalline thin strip 10 are stacked so that, of the opposite surfaces of the nanocrystalline thin strip 10 in the thickness direction F3 (see FIG. 4), the first strip surface 14 (the free surface) faces outwardly of the wound core 1, and the second strip surface 15 (the roll surface) faces inwardly of the wound core 1.

After the stacking process at step S103, a winding process is performed in which the multi-layer nanocrystalline thin strip 10 is wound (step S104). In the winding process at step S104, the multiple layers of the nanocrystalline thin strip 10 are each wound one time, in sequence from the inner side to the outer side, and the opposite end portions in the lengthwise direction F1 of the nanocrystalline thin strip 10 are arranged so as to overlap with each other. In this way, the wound core 1 having the target annular structure is produced. The stacked structure of the multi-layer nanocrystalline thin strip 10 that forms the wound core 1 may have an overlap configuration, a step-lap configuration, or a combination of overlap and step-lap configurations.

After the winding process at step S104, a secondary heat treatment process is performed to nanocrystallize and reduce the stress in the multi-layer nanocrystalline thin strip 10 that forms the wound core 1 (step S105). In the secondary heat treatment process at step S105, the multi-layer nanocrystalline thin strip 10 in the form of the wound core 1 is set in a heating furnace, such as an elevating/lowering high-temperature furnace. Then, the multi-layer nanocrystalline thin strip 10 of the wound core 1 is subjected to the secondary heat treatment with a magnetic field being applied to the wound core 1 in the furnace. This causes nanocrystallization to progress further in each layer of the multi-layer nanocrystalline thin strip 10 from the state after the above-described primary heat treatment to complete the nanocrystallization and also reduces the stress generated in the multi-layer nanocrystalline thin strip 10, for example, during the formation of the wound core 1. The multi-layer nanocrystalline thin strip 10 after the secondary heat treatment is cooled to room temperature while being in the form of the wound core 1 and then taken out of the furnace. This is the end of the production of the wound core 1. Even after the above-described secondary heat treatment, the multiple layers of the nanocrystalline thin strip 10 each have different oxidation degrees at the central portion 11 and at the end portions 12 and 13 in the width direction F2 in FIG. 3. Accordingly, a state in which the oxide film thickness (representative value) and the color are different between the central portion 11 and the end portions 12 and 13 is kept.

The heat treatment temperature of the multi-layer nanocrystalline thin strip 10 in the secondary heat treatment is set similarly to that in the above-described primary heat treatment, but the temperature increase rate of the multi-layer nanocrystalline thin strip 10 may be set to be lower than that in the primary heat treatment.

As explained above, in the embodiment of the present invention, the nanocrystalline thin strip 10 formed of a nanocrystalline material and having an oxidized surface is wound in multiple layers to form the wound core 1, and in each of the multiple layers of the nanocrystalline thin strip 10 forming the wound core 1, an oxidation degree at the central portion 11 in the width direction F2 of the nanocrystalline thin strip 10 is different from an oxidation degree at the end portions 12 and 13 located on both sides of the central portion 11 in the width direction F2 of the nanocrystalline thin strip 10.

When the heat treatment required for nanocrystallization of the nanocrystalline thin strip 10 (particularly, the above-described primary heat treatment) is performed in air, even if the oxidation degree on the surface of the nanocrystalline thin strip 10 (for example, the first and second strip surfaces 14 and 15) is difficult to reduce uniformly, the oxidation degree of the nanocrystalline thin strip 10 can be controlled so that one of the oxidation degree at the central portion 11 and the oxidation degree at the end portions 12 and 13 in the width direction F2 of the nanocrystalline thin strip 10 is lower than the other. This control of the oxidation degree enables the nanocrystalline thin strip 10 to avoid having an excessively thick oxide film 18 on the surface, and thus the internal structure 17 of the nanocrystalline thin strip 10 can have a sufficient volume of the nanocrystalline structure. The wound core 1 produced by winding the nanocrystalline thin strip 10 in multiple layers can have both low core loss and high saturation magnetic flux density and thus can have excellent magnetic properties.

Application of the wound core 1 according to the embodiment of the present invention as a core of a magnetic device, such as a power conversion transformer, can produce a magnetic device having excellent magnetic properties, such as high conversion efficiency. The high saturation magnetic flux density of the wound core 1 allows the magnetic device to be further downsized. In addition, the heat treatment required for nanocrystallization of the nanocrystalline thin strip 10 does not need to be performed in a special gas atmosphere, such as nitrogen gas or inert gas. This eliminates the need for equipment for heat treatment of the nanocrystalline thin strip 10 in the above special gas atmosphere. This can reduce the cost of heat treatment (nanocrystallization) of the nanocrystalline thin strip 10, resulting in a reduction in the production cost of the wound core 1.

In the embodiment of the present invention, the oxidation degree of the opposite end portions 12 and 13 of the nanocrystalline thin strip 10 in the width direction F2 is higher than that of the central portion 11. Thus, performing the heat treatment of the nanocrystalline thin strip 10 in air by focusing on the oxidation degree of the end portions 12 and 13 allows the oxidation degree of the nanocrystalline thin strip 10 to be readily controlled so that not only the end portions 12 and 13 but also the central portion 11 have a low oxidation degree. This enables the nanocrystalline thin strip 10 to readily avoid having an excessively thick oxide film 18 on the surface, and thus a wound core 1 having excellent magnetic properties can be readily produced by using the nanocrystalline thin strip 10.

In the embodiment of the present invention, the opposite surfaces in the thickness direction F3 of the nanocrystalline thin strip 10 each have an oxide film thickness of 5 nm or greater and 350 nm or less, and, in each of the opposite surfaces of the nanocrystalline thin strip 10 in the thickness direction F3, a representative value of the oxide film thickness at the central portion 11 is different from a representative value of the oxide film thickness at the end portions 12, 13. Thus, the oxidation degree of the nanocrystal material thin strip 10 can be controlled so that the central portion 11 or the end portions 12 and 13 of the nanocrystal material thin strip 10 has a smaller oxide film thickness than the other, and also the highest value of the oxide film thickness of the portions can be suppressed to 350 nm or less. This can reduce the core loss of the wound core 1 to a low value of 1.0 W/kg or less when, for example, a maximum magnetic flux density of 1.6 T is generated at a frequency of 50 Hz, enabling the wound core 1 to readily have excellent magnetic properties.

In addition, in the embodiment of the present invention, the outermost thin strip 20 and the innermost thin strip 30 of the multi-layer nanocrystalline thin strip 10 each have a larger representative value of the oxide film thickness than the intermediate thin strip 40 located between the outermost thin strip 20 and the innermost thin strip 30. This enables the wound core 1 formed of the wound multi-layer nanocrystalline thin strip 10 to have a thick oxide film on the inner and outer surfaces 1a and 1b exposed to air in a range in which the target magnetic properties of the wound core 1 are obtained. This oxide film can protect the inner surface 1a and the outer surface 1b of the wound core 1, resulting in an improvement in the weather resistance of the wound core 1.

In the above-described embodiment, a wound core for a power conversion transformer is illustrated, but the present invention should not be limited to this. For example, the wound core may be a wound core used in magnetic devices other than power conversion transformers, such as choke coils.

In the above-described embodiment, the nanocrystalline thin strip has a lower oxidation degree at the central portion in the width direction and has a higher oxidation degree at the end portions, but the present invention should not be limited to this. For example, the nanocrystalline thin strip may have a higher oxidation degree at the central portion in the width direction and a lower oxidation degree at the end portions.

In the above-described embodiment, the wound core has a rounded rectangular annular shape in plan view, but the present invention should not be limited to this. For example, the wound core may have an annular shape other than a rounded rectangular annular shape, such as a circular, oval, or oblong annular shape, in plan view.

In the above-described embodiment, of the opposite surfaces of the nanocrystalline thin strip in the thickness direction, the roll surface faces the heating surface of the heater during the primary heat treatment of the nanocrystalline thin strip. However, the present invention should not be limited to this. For example, in the primary heat treatment of the nanocrystalline thin strip, the free surface may face the heating surface of the heater.

### EXAMPLE

Example of the invention will be indicated below for further detailed explanation of the present invention. Example below should not be construed as limiting the invention. When the term “to” is used, the numerical values before and after “to” are included as the highest and lowest values, unless otherwise specified.

### Example

In Example, multiple samples of the wound core 1 (hereinafter referred to as wound core samples) were produced by the method of producing the wound core 1 according to the embodiment of the present invention. In this production, the nanocrystalline thin strip forming the wound core sample was subjected to the primary heat treatment while being sandwiched between the fixed sheet 52 and the movable sheet 53 described above in the thickness direction F3. The nanocrystalline thin strip was subjected to the secondary heat treatment in a magnetic field while being in the form of the wound core. As in the above-described method of producing the wound core 1, the heat treatment temperature of the nanocrystalline thin strip in the primary and secondary heat treatments was set within the range of −50° C. to +150° C. from the first crystallization temperature at which a-Fe crystals precipitate. Specifically, the heat treatment temperature of the nanocrystalline thin strip in the primary heat treatment was 465° C., and the heat treatment duration was 8 seconds. The heat treatment temperature of the nanocrystalline thin strip in the secondary heat treatment was 450° C., and the heat treatment duration was 10 minutes.

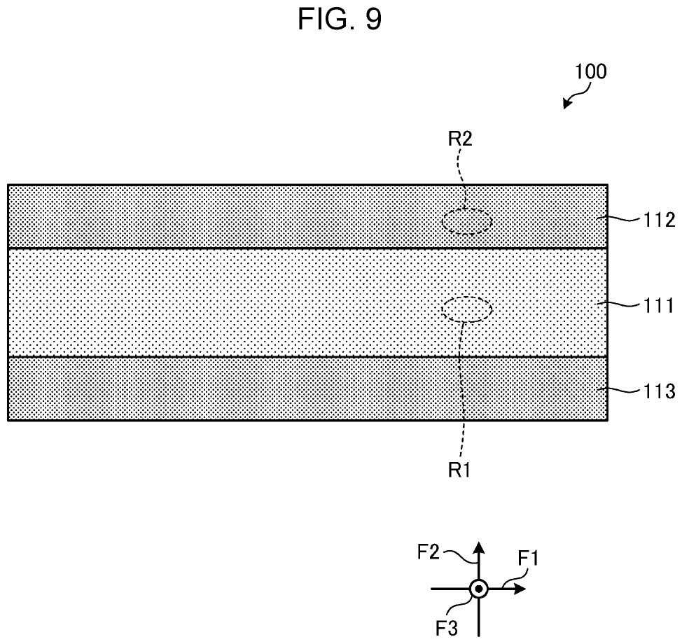

The core loss per unit mass (W/kg) was measured for each of the wound core samples prepared as described above when a maximum magnetic flux density of 1.6 T was generated at a frequency of 50 Hz. In addition, a sample of the nanocrystalline thin strip (hereinafter referred to as a thin strip sample) was taken from each of the wound core samples, and the thin strip samples were each subjected to measurement of the oxide film thickness at the central and end portions in the width direction F2 of the roll surface and at the central and end portions in the width direction F2 of the free surface. FIG. 9 is a schematic view illustrating areas for measurement of an oxide film thickness of a thin strip sample in Example. As indicated in FIG. 9, in a thin strip sample 100 of Example, the central area of the central portion 111 in the width direction F2 was used as a representative site R1 to be measured, and the oxide film thickness of the central portion 111 was measured at the representative site R1. In the thin strip sample 100 of Example, of the opposite end portions 112 and 113 in the width direction F2, the central area of the end portion 112 was used as a representative site R2 to be measured, and the oxide film thickness of the end portion 112 was measured at the representative site R2.

Table 1 below indicates the measurement results of the core loss and oxide film thickness in Example, together with the heat treatment conditions for the primary and secondary heat treatments. In Table 1, “core loss of wound core” is the core loss measured for the wound core samples, and “oxide film thickness” is the oxide film thickness measured for the thin strip samples. The “central portion” is the central portion in the width direction of the thin strip sample, and the “end portion” is the end portion in the width direction of the thin strip sample.

As indicated in Table 1, the core loss was measured for the multiple wound core samples in Example, and the results showed that low core losses of less than 0.5 W/kg (specifically, 0.40 to 0.46 W/kg) were obtained.

In Example, the oxide film thickness was measured for the thin strip samples, and the results showed that the oxide film thickness at the central portion of the roll surface of the thin strip samples ranged from 65 to 193 nm and the oxide film thickness at the end portions of the roll surface ranged from 122 to 223 nm. The oxide film thickness at the central portion of the free surface of the thin strip samples ranged from 83 to 132 nm, and the oxide film thickness at the end portions of the free surface ranged from 106 to 207 nm.

Here, when the above multiple oxide film thicknesses measured in Example are compared for each of the central portion and the end portions, the lowest value of the oxide film thickness at the end portion is the lowest value of the oxide film thickness at the end portion of the free surface (=106 nm), and the lowest value of the oxide film thickness at the central portion is the lowest value of the oxide film thickness at the central portion of the roll surface (=65 nm). Thus, the lowest value of the oxide film thickness at the end portion is higher than that at the central portion. The highest value of the oxide film thickness at the central portion is the highest value of the oxide film thickness at the central portion of the roll surface (=193 nm), and the highest value of the oxide film thickness at the end portion is the highest value of the oxide film thickness at the end portion of the roll surface (=223 nm). Thus, the highest value of the oxide film thickness at the central portion is lower than that at the end portion.

Thus, both for the roll and free surfaces, the median of the oxide film thickness at the end portions is larger than the median of the oxide film thickness at the central portion. Specifically, the median of the oxide film thickness at the end portions of the roll surface is 172.5 nm, and the median of the oxide film thickness at the end portions of the free surface is 156.5 nm. The median of the oxide film thickness at the central portion of the roll surface is 129 nm, and the median of the oxide film thickness at the central portion of the free surface is 107.5 nm. The above shows that the oxide film thickness at the end portions is larger than that at the central portion in Example.

In Example, a sample of the outermost thin strip, a sample of the innermost thin strip, and a sample of the intermediate thin strip were taken from each of the wound core samples, and the oxide film thickness was measured at a representative site of each of the samples. The measurement results showed that the outermost thin strip had an oxide film thickness of 223 nm, the innermost thin strip had an oxide film thickness of 153 nm, and the intermediate thin strip had an oxide film thickness of 114 nm. When the oxide film thicknesses are compared, the oxide film thickness of the intermediate thin strip is smaller than that of the outermost thin strip and that of the innermost thin strip.

Focusing on the core loss and oxide film thickness in Example, the highest value of the oxide film thickness was 350 nm or less (specifically, 315 nm or less), and the core loss of the wound core at this time (measurement conditions: frequency=50 Hz, maximum magnetic flux density=1.6 T) was found to be 1.0 W/kg or less (specifically, less than 0.5 W/kg).

### Comparative Example

Next, Comparative Example for comparison with the present invention will be described. In Comparative Example, the above-described fixed and movable sheets 52 and 53 were eliminated, and the primary heat treatment was performed on the nanocrystalline thin strip by heating the nanocrystalline thin strip from one side in the thickness direction F3 using the heater 51. Multiple samples of the wound cores were produced in Comparative Example by the same production method as in Example, except for the method of the above-described primary heat treatment. The heat treatment conditions for the primary and secondary heat treatments in Comparative Example were the same as those in Example.

In Comparative Example, the core loss (W/kg) was measured for each of the wound core samples produced as described above under the same measurement conditions as in Example. The thin strip samples taken from each of the wound core samples were each subjected to measurement of the oxide film thickness at the central portion and the end portions in the width direction F2 of the roll surface and at the central portion and the end portions in the width direction F2 of the free surface.

Table 1 indicates the measurement results of the core loss and oxide film thickness in Comparative Example, together with the heat treatment conditions for the primary and secondary heat treatments. As indicated in Table 1, the core losses measured for the wound core samples in Comparative Example were in a range of 3.8 to 4.2 W/kg, which are much higher than those in Example. In Comparative Example, the thin strip sample had an oxide film thickness of about 800 nm on the roll surface and about 900 nm on the free surface with no difference in the oxide film thickness between the central portion and the end portion F2 in the width direction. In other words, the oxide film thickness of the thin strip samples in Comparative Example was thicker than that in Example and exceeded 350 nm. The core loss of the wound core in Comparative Example (measurement conditions: frequency=50 Hz, maximum magnetic flux density=1.6 T) was high, exceeding 1.0 W/kg.

TABLE 1

| | | | Core Loss of | | | | |
|---|---|---|---|---|---|---|---|
| | | | Wound Core | | | | |
| | Heat Treatment Conditions | | (W/kg) | Oxide Film Thickness (nm) | | | |
| | Primary | Secondary | (Measurement | Roll Surface | | Free Surface | |
| | Heat | Heat | Conditions: | Central | End | Central | End |
| | Treatment | Treatment | 1.6 T, 50 Hz) | Portion | portion | Portion | Portion |
| Example | 465° C. | 450° C. | 0.40 to | 65 to | 122 to | 83 to | 106 to |
| | 8 sec | 10 min | 0.46 | 193 | 223 | 132 | 207 |
| Comparative | 465° C. | 450° C. | 3.8 to | About 800 | | About 900 | |
| Example | 8 sec | 10 min | 4.2 | | | | |

The present invention should not be limited by the above-described embodiment and Example. The present invention also includes configurations having suitable combinations of the components described above. Other embodiments, Examples, operational techniques, and the like which are performed by a person skilled in the art based on the above embodiment are all included in the scope of the present invention.

As described above, the wound core according to the embodiment of the present invention is suitable as a wound core having excellent magnetic properties.

What is claimed is:

1. A wound core comprising:
a thin strip formed of a nanocrystalline material, having an oxidized surface, and wound in multiple layers, wherein
the thin strip has an oxidation degree at a central portion in a width direction of the thin strip that is different from an oxidation degree at end portions located on both sides of the central portion in the width direction of the thin strip.

2. The wound core according to claim 1, wherein the thin strip has a higher oxidation degree at the end portions than at the central portion.

3. The wound core according to claim 1, wherein opposite surfaces in a thickness direction of the thin strip each have an oxide film thickness of 5 nm or greater and 350 nm or less, and,
in each of the opposite surfaces of the thin strip in the thickness direction, a representative value of the oxide film thickness at the central portion is different from a representative value of the oxide film thickness at the end portions.

4. The wound core according to claim 1, wherein, in each of opposite surfaces of the thin strip in a thickness direction, a color at the central portion is different from a color at the end portions.

5. The wound core according to claim 1, wherein an outermost thin strip and an innermost thin strip of the thin strip in multiple layers each have a larger representative value of an oxide film thickness than an intermediate thin strip located between the outermost thin strip and the innermost thin strip.
